(19) United States
(12) Patent Application Publication
(10) Pub. No.: US 2024/0179559 A1
(43) Pub. Date: May 30, 2024

(54) QOS CONTROL METHOD AND APPARATUS, AND COMMUNICATION DEVICE

(71) Applicant: GUANGDONG OPPO MOBILE TELECOMMUNICATIONS CORP., LTD., Dongguan (CN)

(72) Inventor: Yang XU, Dongguan (CN)

(73) Assignee: GUANGDONG OPPO MOBILE TELECOMMUNICATIONS CORP., LTD., Dongguan (CN)

(21) Appl. No.: 18/427,735

(22) Filed: Jan. 30, 2024

Related U.S. Application Data
(63) Continuation of application No. PCT/CN2021/113117, filed on Aug. 17, 2021.

(51) Int. Cl. H04W 28/02; H04W 28/08; H04W 28/24

(52) U.S. Cl. CPC H04W 28/0268; H04W 28/0908; H04W 28/24

(57) ABSTRACT

A quality of service (QoS) control method and apparatus are provided. The method includes: a first node receives a first request message sent by a second node, here, the first request message carries at least one of a value of a round-trip QoS parameter or transmission time information; and the first node determines a value of an uplink QoS parameter and a value of a downlink QoS parameter based on the value of the round-trip QoS parameter, and/or determines an uplink transmission time window and a downlink transmission time window based on the transmission time information.

### CROSS-REFERENCE TO RELATED APPLICATION(S)

This application is a continuation of International Patent Application No. PCT/CN 2021/113117 filed on Aug. 17, 2021, the entire contents of which are incorporated by reference herein in its entirety.

### BACKGROUND

In current QoS mechanisms, QoS parameters are unchanged during the entire transmission process of a QoS flow, and the QoS parameters can only satisfy one-way QoS requirements. For example, the QoS parameters can only satisfy the QoS requirements of uplink transmission or can only satisfy the QoS requirements of downlink transmission.

However, for certain services, the current QoS mechanisms cannot satisfy the QoS requirements of such services. For example, for an interactive service, the current QoS mechanisms cannot satisfy the round-trip QoS requirements for such a service. For another example, for a service that has specific QoS requirements within a specific time range, the current QoS mechanisms cannot satisfy the QoS requirements of such a service within the specific time range.

### SUMMARY

Embodiments of the present disclosure relate to the technical field of mobile communications, and provide a QoS control method and apparatus, a chip, and a non-transitory computer-readable storage medium.

In a first aspect, an embodiment of the present disclosure provides a QoS control method, which includes the following operations.

A first node receives a first request message sent by a second node, where the first request message carries at least one of: a value of a round-trip QoS parameter or transmission time information.

The first node determines a value of an uplink QoS parameter and a value of a downlink QoS parameter based on the value of the round-trip QoS parameter, and/or determines an uplink transmission time window and a downlink transmission time window based on the transmission time information.

In a second aspect, an embodiment of the present disclosure provides a QoS control method, which includes the following operations.

A second node sends a first request message to a first node, where the first request message carries at least one of: a value of a round-trip QoS parameter or transmission time information.

The value of the round-trip QoS parameter is used by the first node to determine a value of an uplink QoS parameter and a value of a downlink QoS parameter; and/or the transmission time information is used by the first node to determine an uplink transmission time window and a downlink transmission time window.

In third aspect, an embodiment of the present disclosure provides a QoS control apparatus, which is applied to a first node and includes a transceiver, a processor and a memory.

The memory is configured to store a computer program that, when executed by the processor, causes the processor to: receive, through the transceiver, a first request message sent by a second node, where the first request message carries at least one of: a value of a round-trip QoS parameter or transmission time information; and determine a value of an uplink QoS parameter and a value of a downlink QoS parameter based on the value of the round-trip QoS parameter, and/or to determine an uplink transmission time window and a downlink transmission time window based on the transmission time information.

In fourth aspect, an embodiment of the present disclosure provides a QoS control apparatus, which is applied to a second node and includes a transceiver, a processor and a memory.

The memory is configured to store a computer program that, when executed by the processor, causes the processor to: send a first request message to a first node through the transceiver, where the first request message carries at least one of: a value of a round-trip QoS parameter or transmission time information.

The value of the round-trip QoS parameter is used by the first node to determine a value of an uplink QoS parameter and a value of a downlink QoS parameter; and/or the transmission time information is used by the first node to determine an uplink transmission time window and a downlink transmission time window.

In fifth aspect, an embodiment of the present disclosure provides a chip configured to implement the QoS control method in the first aspect or the second aspect.

Specifically, the chip includes a processor configured to invoke and run a computer program from a memory, so that a device having the chip installed thereon performs the QoS control method in the first aspect or the second aspect.

In sixth aspect, an embodiment of the present disclosure provides a non-transitory computer-readable storage medium storing a computer program which causes a computer to perform the QoS control method in the first aspect or the second aspect.

### BRIEF DESCRIPTION OF THE DRAWINGS

The drawings illustrated here are used to provide a further understanding of the present disclosure, and constitute a part of the present disclosure. The illustrative embodiments of the present disclosure and the description thereof are used to explain the present disclosure, and do not constitute an improper limitation to the present disclosure. In the drawings:

FIG. 1 is a schematic diagram of an application scenario according to an embodiment of the present disclosure.

FIG. 2 is a schematic diagram of a total round-trip time provided in an embodiment of the present disclosure.

FIG. 3 is a schematic diagram of a model separation scenario provided in an embodiment of the present disclosure.

FIG. 4 is a schematic diagram of a QoS flow mapping mechanism provided in an embodiment of the present disclosure.

FIG. 5 is a first schematic flowchart of a QoS control method provided in an embodiment of the present disclosure;

FIG. 6 is a second schematic flowchart of a QoS control method provided in an embodiment of the present disclosure;

FIG. 7 is a third schematic flowchart of a QoS control method provided in an embodiment of the present disclosure;

FIG. 8 is a schematic diagram of the time involved in a round-trip data interaction process provided in an embodiment of the present disclosure;

FIG. 9 is a fourth schematic flowchart of a QoS control method provided in an embodiment of the present disclosure;

FIG. 10 is a fifth schematic flowchart of a QoS control method provided in an embodiment of the present disclosure;

FIG. 11 is a first schematic diagram of the structural composition of a QoS control apparatus provided in an embodiment of the present disclosure;

FIG. 12 is a second schematic diagram of the structural composition of a QoS control apparatus provided in an embodiment of the present disclosure;

FIG. 13 is a schematic structural diagram of a communication device provided in an embodiment of the present disclosure;

FIG. 14 is a schematic structural diagram of a chip according to an embodiment of the present disclosure; and

FIG. 15 is a schematic block diagram of a communication system provided in an embodiment of the present disclosure.

### DETAILED DESCRIPTION

The technical solutions in the embodiments of the present disclosure are described below with reference to the drawings in the embodiments of the present disclosure. It is apparent that the described embodiments are part of the embodiments of the present disclosure, rather than all of the embodiments. All other embodiments that are arrived at by a person of ordinary skill in the art on the basis of the embodiments in the present disclosure without involving inventive skill fall within to the scope of protection of the present disclosure.

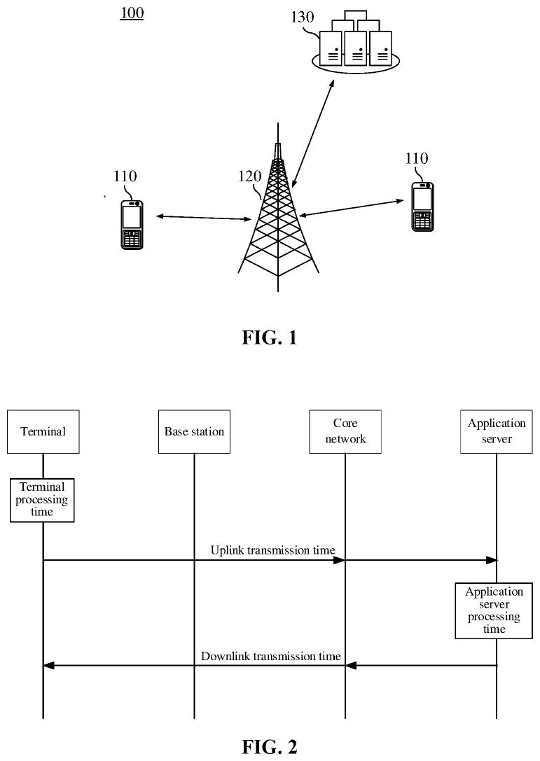

FIG. 1 is a schematic diagram of an application scenario according to an embodiment of the present disclosure.

As illustrated in FIG. 1, a communication system 100 includes terminals 110 and a network device 120. The network device 120 may communicate with the terminals 110 through an air interface. Multi-service transmission are supported between the terminals 110 and the network device 120.

It should be understood that the embodiment of the present disclosure is only exemplified by using the communication system 100, but the embodiment of the present disclosure is not limited thereto. That is, the technical solution of the embodiment of the present disclosure may be applied to various communication systems, such as: a long term evolution (LTE) system, LTE time division duplex (TDD), a universal mobile telecommunication system (UMTS), an Internet of Things (IOT) system, a narrow band Internet of Things (NB-IOT) system, an enhanced machine-type communications (eMTC) system, a 5G communication system (also referred to as a new radio (NR) communication system), or future communication systems, and the like.

In the communication system 100 illustrated in FIG. 1, the network device 120 may be an access network device that communicates with the terminals 110. The access network device may provide communication coverage for a particular geographic region, and may perform communication with the terminals 110 (e.g., UE) located within the coverage region.

The network device 120 may be an evolved base station (evolutional node B, eNB or eNodeB) in a long term evolution (LTE) system, a next generation radio access network (NG RAN) device, a base station (gNB) in an NR system, or a wireless controller in a cloud radio access network (CRAN). Or, the network device 120 may be a relay station, an access point, a vehicle-mounted device, a wearable device, a hub, a switch, a bridge, a router, a network device in a future evolved public land mobile network (PLMN), or the like.

Each terminal 110 may be any terminal, including but not limited to a terminal that is connected to the network device 120 or other terminals by means of wired or wireless.

For example, the terminal 110 may refer to an access terminal, a user equipment (UE), a user unit, a user station, a mobile station, a mobile site, a remote station, a remote terminal, a mobile device, a user terminal, a terminal, a wireless communication device, a user agent, or a user apparatus. The access terminal may be a cellular phone, a cordless phone, a session initiation protocol (SIP) phone, an IoT device, a satellite handheld terminal, a wireless local loop (WLL) station, a personal digital assistant (PDA), a handheld device having a wireless communication function, a computing device or another processing device connected to a wireless modem, a vehicle-mounted device, a wearable device, a terminal in a 5G network, a terminal in a future evolved network, or the like.

The terminals 110 may be used for device-to-device (D2D) communication.

The wireless communication system 100 may further include a core network device 130 that is in communication with a base station. The core network device 130 may be a 5G core network (5G Core, 5GC) device, for example, an access and mobility management function (AMF), or as another example, an authentication server function (AUSF), or as another example, a user plane function (UPF), and as another example, a session management function (SMF). Optionally, the core network device 130 may also be an evolved packet core (EPC) device of an LTE network, for example, a session management function+core packet gateway (SMF+PGW-C) device. It should be understood that the SMF+PGW-C can simultaneously achieve the functions that an SMF and a PGW-C can achieve. During the process of network evolution, the above-mentioned core network device may also be called by other names, or a new network entity may be formed by dividing the functions of a core network, and the embodiment of the present disclosure is not limited thereto.

Connections may be established between various functional units in the communication system through a next generation (NG) network interface to implement communication.

For example, the terminal establishes an air interface connection with the access network device through an NR interface to transmit user plane data and control plane signaling. The terminal may establish a control plane signaling connection with an AMF through an NG interface 1 (N1 for short). The access network device, e.g., a next generation radio access base station (gNB), may establish a user plane data connection with a UPF through an NG interface 3 (N3 for short). The access network device may establish a control plane signaling connection with the AMF through an NG interface 2 (N2 for short). The UPF may establish a control plane signaling connection with an SMF through an NG interface 4 (N4 for short). The UPF may exchange user plane data with a data network through an NG interface 6 (N6 for short). The AMF may establish a control plane signaling connection with the SMF through an NG interface 11 (N11 for short). The SMF may establish a control plane signaling connection with a policy control function (PCF) through an NG interface 7 (N7 for short).

FIG. 1 illustratively illustrates one base station, one core network device and two terminals. Optionally, the wireless communication system 100 may include a plurality of base station devices, and may include other numbers of terminals within the coverage range of each base station. The embodiment of the present disclosure is not limited thereto.

It should be noted that FIG. 1 only illustrates, as an example, a system to which the present disclosure is applicable. Of course, the methods shown in the embodiments of the present disclosure may also be applied to other systems. In addition, the terms “system” and “network” herein are often used interchangeably herein. The term “and/or” herein is merely to describe the associations of associated objects, indicating that there can be three kinds of relationships. For example, A and/or B can indicate three situations in which A exists alone, A and B exist simultaneously, or B exists alone. In addition, the character “/” herein generally indicates that the associated objects before and after this character are in an “or” relationship. It should also be understood that “indicating” mentioned in the embodiments of the present disclosure may be a direct indication or may be an indirect indication, or may also represent an association. By way of example, A indicating B may represent that A directly indicates B, for example, B may be acquired by means of A; or may represent that A indirectly indicates B, for example, A indicates C, and B may be acquired by means of C; or may represent that A and B have an association. It should also be understood that “corresponding” mentioned in the embodiments of the present disclosure may represent that there is a direct correspondence or indirect correspondence between two objects, or may represent an association therebetween, or may be the relationship between indicating and being indicated and configuring and being configured, etc. It should also be understood that “predefined” or “predefined rules” mentioned in the embodiments of the present disclosure may be implemented by pre-storing corresponding codes, tables, or other means available for indicating relevant information in a device (e.g., including a terminal and a network device), and the present disclosure does not limit the specific implementation thereof. For example, predefined may refer to being defined in a protocol. It should also be understood that in the embodiments of the present disclosure, the “protocol” may refer to a standard protocol in the field of communications, for example, it may include an LTE protocol, an NR protocol, and related protocols applied to future communication systems, and the present disclosure is not limited thereto.

To facilitate the understanding of the technical solutions of the embodiments of the present disclosure, the following related technologies of the embodiments of the present disclosure are described below. The following related technologies can be arbitrarily combined with the technical solutions of the embodiments of the present disclosure as optional solutions, all of which fall within the scope of protection of the embodiments of the present disclosure.

There are many services that need to consider the total round-trip time for uplink and downlink, which includes uplink calculation time, uplink transmission time, downlink calculation time, and downlink transmission time. As illustrated in FIG. 2, the terminal first processes obtained data, and sends a processing result to an application server through a communication network. Then, the application server performs processing to obtain a result, and the application server sends the result to the terminal through the communication network. In this process, total time=terminal processing time+uplink transmission time+server processing time+downlink transmission time. Similarly, the data may also be first processed by the application server and then sent to the terminal, and the processed result is sent by the terminal to the application server.

In some optional implementations, the core network in FIG. 2 may specifically refer to the UPF in the core network. Using the UPF in the core network as an example, the uplink transmission time may be transmission time from the terminal to the UPF, and the downlink transmission time may be transmission time from the UPF to the terminal. Alternatively, the uplink transmission time may be transmission time from the terminal to the application server, and the downlink transmission time may be transmission time from the application server to the terminal. In some cases, when the application server is closer to the UFP, for example, when deployed in the same region, the transmission time between the core network and the application server may be ignored, and in such a case, the uplink transmission time or the downlink transmission time refers to the transmission time between the terminal and the UPF. In some cases, the transmission time between the UPF and the application server may be considered to not belong to a time delay consideration factor in the 3GPP specification, and in such a case, the uplink transmission time or downlink transmission time refers to the transmission time between the terminal and UPF.

It should be noted that in the solutions related to a “transmission time window” that will be described later in the present disclosure, the duration of the transmission time window may consider the transmission time from the core network to the application server, or may not consider the transmission time from the core network to the application server. For example, the duration of an uplink transmission time window corresponds to the duration of the transmission time from the terminal to the UPF, or the duration of the uplink transmission time window corresponds to the duration of the transmission time from the terminal to the application server. For another example, the duration of a downlink transmission time window corresponds to the duration of the transmission time from the UFP to the terminal, or the duration of the downlink transmission time window corresponds to the duration of the transmission time from the application server to the terminal.

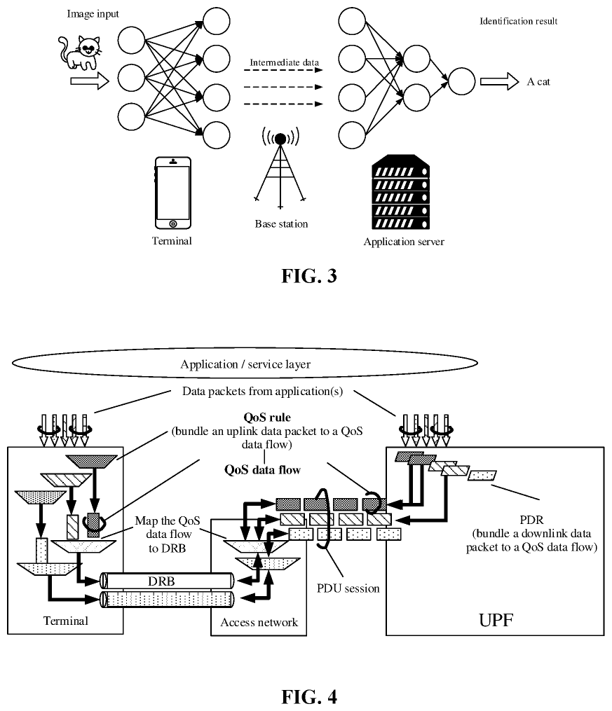

In accordance with the principles above, a detailed example will be provided in combination with one common scenario in artificial intelligence (AI)/machine learning (ML) inference. To enable the effect and user experience of big data analysis to be improved, employing a multi-stage AI/ML means can be considered, that is, a network element on the network side and a terminal perform big data analysis by dividing the work. A typical division of work is illustrated in FIG. 3. The terminal performs partial operations on the data to form intermediate data, and then sends the intermediate data to the application server through a mobile network for further calculation. Finally, the application server calculates that the image that can be captured by the terminal is “a cat” and returns the result to the terminal.

When a model has many layers, a layer at which data is split (referred to as a split point) will cause different computing resource consumption, computing time, transmission rates, transmission delays, etc., between the terminal and the application server. As an example, as shown in Table 1 below, for a visual geometry group (VGG)-16 model, using a refresh rate of 30 frames/second as an example, a different split point location will result in a different data size outputted by the terminal side and a different required uplink transmission rate sent to the server.

TABLE 1

| | | Required uplink |
|---|---|---|
| | Outputted data size | transmission rate |
| Split point | (MByte) | (Mbps) |
| Candidate split point 0 | 0.6 | 145 |
| (Clould-based inference) | | |
| Candidate split point 1 | 3 | 720 |
| (after pool1 layer) | | |
| Candidate split point 2 | 1.5 | 360 |
| (after pool2 layer) | | |
| Candidate split point 3 | 0.8 | 192 |
| (after pool3 layer) | | |
| Candidate split point 4 | 0.5 | 120 |
| (after pool4 layer) | | |
| Candidate split point 5 | 0.1 | 24 |
| (after pool5 layer) | | |
| Candidate split point 6 | N/A | N/A |
| (Device-based inference) | | |

For the service in said scenario, the main concern is the total processing time of uplink and downlink and the total transmission time of uplink and downlink. If the total time is within a certain range (e.g., 1 s), then this means that any picture taken by the terminal can result in a corresponding text annotation result within one second.

To ensure data transmission, a mobile communication network generally uses a QoS mechanism. As illustrated in FIG. 4, in a mobile communications network, in order to be able to transmit user plane data, one or more QoS flows need(s) to be established, and different QoS flows correspond to different QoS parameters. As an important measure of communication quality, QoS parameters are usually used to indicate the features of QoS flows. QoS parameters may include, but are not limited to: a 5G QoS identifier (5QI), allocation retention priority (ARP), guaranteed flow bit rate (GFBR), maximum flow bit rate (MFBR), uplink/downlink maximum packet loss rate (UL/DL MPLR), end-to-end packet delay budget (PDB), AN-PDB, packet error rate (PER), priority level, averaging window, resource type, maximum data burst volume, UE aggregate maximum bit rate (UE-AMBR), session aggregate maximum bit rate (session-AMBR), and the like.

A filter (or referred to as an service data flow SDF template in a Packet detection rule PDR) includes feature parameters that describe data packets, and is configured to filter out a specific data packet so as to bundle the same to a particular QoS flow. Here, the most commonly used filter is an IP five-tuple, i.e., a source IP address, a destination IP address, a source port number, a destination port number, and a protocol type.

A network-side user plane network element (e.g., a UPF) and a terminal may form a filter (for example, the leftmost trapezoid and the rightmost parallelogram in FIG. 4 represent a filter) according to a combination of the feature parameters of the data packets, and an uplink or downlink data packet that is transmitted on a user plane and that satisfies the feature parameters of the data packets is filtered by the filter and bundled to a certain QoS flow. An uplink QoS flow is bundled by the terminal, and a downlink QoS flow is bundled by the network-side user plane network element (e.g., the UPF). In the QoS mechanism, one or more QoS flows may be mapped onto one air interface resource for transmission, and as an example, the air interface resource may be a data radio bearer (DRB). With regards to one QoS flow, the same corresponds to a set of QoS parameters, and an access network establishes DRBs according to the QoS parameters and bundles the QoS flow to a particular DRB.

The QoS flow is triggered and established by a session management function (SMF) network element. When the QoS needs to be adjusted, both the terminal and the network side may trigger a PDU session modification process, thereby changing QoS. Using the terminal as an example, the terminal may modify the QoS parameters of the QoS flow or establish a new QoS flow by sending a PDU session modification request message. That is, when the terminal adjusts QoS, a session modification process needs to be performed, and the consent of a network must be obtained. Since the PDU session modification process requires a longer time and it is also not possible to guarantee that the modification will definitely be successful, the behavior of the application will thus be affected, that is, the application cannot accurately determine if and how often to use its desired QoS, which will have a great impact on many real-time services, such as machine learning and neural network analysis. There are many situations that cause QoS changes. As examples, the following situations may cause QoS changes: 1) base station handover occurs; 2) network congestion occurs (e.g., a sudden increase in the number of users); and 3) a terminal moves into or out of a specific range (e.g., a service range of an edge server).

Currently, the QoS mechanism is for one-way transmission. For example, uplink transmission corresponds to a separate QoS parameter, and downlink transmission corresponds to a separate QoS parameter. Moreover, the QoS parameters are unchanged in the same QoS flow. However, many interactive services focus on the total round-trip time (delay) and do not care about how big the one-way time (delay) really is. Therefore, a QoS control mechanism for uplink and downlink round-trip transmission is needed for more reasonable and dynamic invocation of uplink and downlink transmission resources, thereby achieving the purpose of the total round-trip delay satisfying QoS requirements. For this reason, the following technical solutions of the embodiments of the present disclosure are proposed.

To facilitate understanding of the technical solutions of the embodiments of the present disclosure, the technical solutions of the present disclosure will be described in detail below by means of specific embodiments. The above related technologies may be arbitrarily combined with the technical solutions of the embodiments of the present disclosure as optional solutions, all of which fall within the scope of protection of the embodiments of the present disclosure. The embodiments of the present disclosure include at least some of the following contents.

It should be noted that the technical solutions of the embodiments of the present disclosure may be applied to any communication system including, but not limited to, a 5G system (5GS), a 6G system (6GS), and the like.

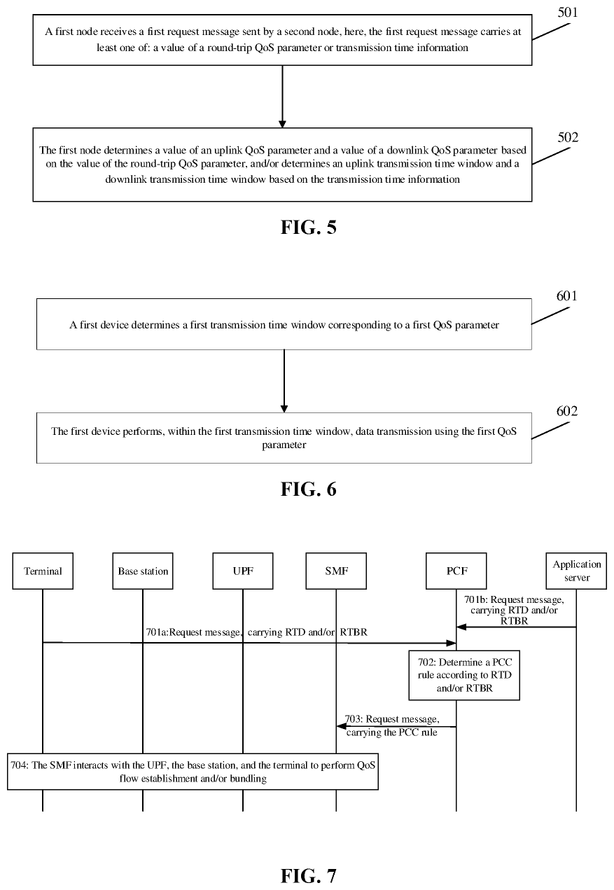

FIG. 5 is a first schematic flowchart of a QoS control method provided in an embodiment of the present disclosure. As illustrated in FIG. 5, the QoS control method includes the following operations.

In block 501: a first node receives a first request message sent by a second node, here, the first request message carries at least one of: a value of a round-trip QoS parameter or transmission time information.

In block 502: the first node determines a value of an uplink QoS parameter and a value of a downlink QoS parameter based on the value of the round-trip QoS parameter, and/or determines an uplink transmission time window and a downlink transmission time window based on the transmission time information.

According to the embodiment of the present disclosure, in one aspect, the value of the uplink QoS parameter and the value of the downlink QoS parameter are determined on the basis of the value of the round-trip QoS parameter, so that the uplink QoS parameter and the downlink QoS parameter satisfy round-trip QoS requirements, thus achieving the objective of QoS control of uplink and downlink round-trip transmission. In another aspect, the transmission time window is introduced, and data transmission is performed using a specific QoS parameter within the transmission time window, thereby achieving the objective of satisfying a specific QoS requirement within a specific time range.

In some optional implementations, the first node is a policy control network element. As an example, the first node is a policy control function (PCF).

In some optional implementations, the second node is a terminal or an application server.

As an example, the policy control network element receives a first request message sent by the terminal, the first request message carrying at least one of: a value of a round-trip QoS parameter or transmission time information. The policy control network element determines a value of an uplink QoS parameter and a value of a downlink QoS parameter based on the value of the round-trip QoS parameter, and/or determines an uplink transmission time window and a downlink transmission time window based on the transmission time information.

As an example, the policy control network receives a first request message sent by the application server, the first request message carrying at least one of: a value of a round-trip QoS parameter or transmission time information. The policy control network element determines a value of an uplink QoS parameter and a value of a downlink QoS parameter based on the value of the round-trip QoS parameter, and/or determines an uplink transmission time window and a downlink transmission time window based on the transmission time information.

### Related Solutions for QoS Parameters

In an embodiment of the present disclosure, the first node determines a value of an uplink QoS parameter and a value of a downlink QoS parameter based on the value of the round-trip QoS parameter.

In some optional implementations, the QoS parameter includes at least one of: delay or bit rate.

In an embodiment of the present disclosure, the sum of the value of the uplink QoS parameter and the value of the downlink QoS parameter is less than or equal to the value of the round-trip QoS parameter.

As an example, using the QoS parameter being the delay as an example, the sum of the value of an uplink delay and the value of a downlink delay is less than or equal to the value of a round-trip delay. Here, the round-trip delay is also known as an RTD.

As an example, using the QoS parameter being the bit rate as an example, the sum of the value of an uplink bit rate and the value of a downlink bit rate is less than or equal to the value of a round-trip bit rate. Here, the round-trip bit rate is also known as an RTBR.

In the above solutions, the value of the uplink QoS parameter and the value of the downlink QoS parameter need to be less than or equal to the value of the round-trip QoS parameter, thereby ensuring round-trip QoS requirements.

In an embodiment of the present disclosure, the uplink QoS parameter is applied to transmission of uplink data, and the downlink QoS parameter is applied to transmission of downlink data. In some optional implementations, the uplink data and the downlink data are data belonging to the same service or application. Here, the uplink data and downlink data belonging to the same service or application may be configured with corresponding SDF templates in a core network, and each SDF template corresponds to a different QoS parameter. Here, the SDF templates each include feature parameters describing data packets. Furthermore, the policy control network element may determine, according to the SDF templates, filters respectively corresponding to an uplink data packet and downlink data packet, and data packets screened out by the filters are bundled to corresponding QoS flows for transmission.

In an embodiment of the present disclosure, after the first node determines the value of the uplink QoS parameter and the value of the downlink QoS parameter based on the value of the round-trip QoS parameter, the first node determines a first rule, here, the first rule includes the value of the uplink QoS parameter and the value of the downlink QoS parameter. The first node sends the first rule to a third node, here, the first rule is used by the third node for establishment and/or bundling of a QoS flow.

In some optional implementations, the third node is a session management network element. As an example, the third node is an SMF.

In an embodiment of the present disclosure, after obtaining the first rule, the third node performs the establishment and/or bundling of the QoS flow based on the first rule. Here, the QoS flow includes an uplink QoS flow and a downlink QoS flow, a QoS parameter used by the uplink QoS flow is the uplink QoS parameter, and a QoS parameter used by the downlink QoS flow is the downlink QoS parameter.

In some optional implementations, the uplink QoS flow and the downlink QoS flow are the same QoS flow.

In some optional implementations, the uplink QoS flow and the downlink QoS flow are different QoS flows.

In some optional implementations, the first rule may be a policy control service (PCC) rule. Furthermore, the first rule further includes SDF templates. The uplink data and downlink data belonging to the same service or application may be configured with corresponding SDF templates, and each SDF template corresponds to a different QoS parameter. The third node determines, based on the SDF templates, filters respectively corresponding to an uplink data packet and a downlink data packet, and data packets screened out by the filters are bundled to corresponding QoS flows.

### Related Solutions for Transmission Time Windows

In an embodiment of the present disclosure, the first node determines an uplink transmission time window and a downlink transmission time window based on the transmission time information.

In some optional implementations, the uplink transmission time window is determined based on at least one of the following pieces of information: a starting position of the uplink transmission time window, an ending position of the uplink transmission time window, or a duration of the uplink transmission time window.

In some optional implementations, the downlink transmission time window is determined based on at least one of the following pieces of information: a starting position of the downlink transmission time window, an ending position of the downlink transmission time window, or a duration of the downlink transmission time window.

On the basis of the foregoing, the transmission time information may include one or more of the above pieces of information. For example, the transmission time information includes the duration of the uplink transmission time window and the duration of the downlink transmission time window.

In an embodiment of the present disclosure, after the first node determines the uplink transmission time window and the downlink transmission time window based on the transmission time information, the first node indicates the uplink transmission time window and the downlink transmission time window to at least one of the following devices: a terminal, an access network element (e.g., a base station), or a core network element (e.g., a UPF).

In the above solutions, the uplink transmission time window is applicable to uplink data transmission using the uplink QoS parameter, and the downlink transmission time window is applicable to downlink data transmission using the downlink QoS parameter. As such, the uplink data and the downlink data may be transmitted according to the corresponding QoS parameters in accordance with mechanisms of the transmission time windows.

In the technical solutions of the embodiments of the present disclosure, the terminal and the network may control the transmission of uplink data and downlink data according to the time windows, thereby ensuring the total QoS requirements of the uplink data and downlink data. In addition, in the technical solutions of the embodiments of the present disclosure, the foregoing is simple to implement, does not require a third party to do additional work, or does not require deep packet inspection capabilities. Further still, the technical solutions of the embodiments of the present disclosure adequately use existing architecture and signaling, and have a smaller impact on existing protocols.

FIG. 6 is a second schematic flowchart of a QoS control method provided in an embodiment of the present disclosure. As illustrated in FIG. 6, the QoS control method includes the following operations.

In block 601: a first device determines a first transmission time window corresponding to a first QoS parameter.

In block 602: the first device performs, within the first transmission time window, data transmission using the first QoS parameter.

In the embodiment of the present disclosure, the first transmission time window may be an uplink transmission time window or a downlink transmission time window, here, the uplink transmission time window is applicable to uplink data transmission using an uplink QoS parameter, and the downlink transmission time window is applicable to downlink data transmission using a downlink QoS parameter. As such, the uplink data and the downlink data may be transmitted according to the corresponding QoS parameters in accordance with the mechanisms of the transmission time windows.

### First Solution

In an embodiment of the present disclosure, the first device includes at least one of: a terminal, an access network element, or a core network element; and the first transmission time window is an uplink transmission time window. The first device determines the starting time of the uplink transmission time window, and opens the uplink transmission time window when the starting time is reached. Here, the access network element is, for example, a base station. The core network element is, for example, a UPF.

Here, the first device may refer to one device among the terminal, the access network element, and the core network element. For example, the first device is the terminal. Alternatively, the first device may include at least two devices among the terminal, the access network element, and the core network element. With regard to these situations, the at least two devices all determine the starting time of the uplink transmission time window, and open the uplink transmission time window when the starting time is reached. Using the terminal as an example, after opening the uplink transmission time window, the terminal sends uplink data to the access network element within the uplink transmission time window. Using the access network element as an example, after opening the uplink transmission time window, the access network element sends uplink data to the core network element within the uplink transmission time window. Using the core network element as an example, after opening the uplink transmission time window, the core network element sends uplink data to an application server within the uplink transmission time window.

In an embodiment of the present disclosure, the first device may determine the starting time of the uplink transmission time window by the following manners.

Manner 1: the first device determines the starting time of the uplink transmission time window based on network configuration information.

Manner 2: The first device determines the starting time of the uplink transmission time window based on predefined information.

Manner 3: The first device determines the starting time of the uplink transmission time window based on implementation by the first device itself.

In some optional implementations, the first device determines the starting time of the uplink transmission time window as the time when the first device sends a first uplink data packet in a first QoS flow.

In some optional implementations, within the uplink transmission time window, uplink data packet(s) in the first QoS flow is transmitted using the first QoS parameter, and outside of the uplink transmission time window, the uplink data packet(s) in the first QoS flow is transmitted using a second QoS parameter or not transmitted. Here, the second QoS parameter may be a QoS parameter of a lower level compared with the first QoS parameter.

Furthermore, in some optional implementations, after performing uplink transmission within the uplink transmission time window, the first device may also perform downlink transmission within a downlink transmission time window. To this end, the first device determines the starting time of the downlink transmission time window and opens the downlink transmission time window when the starting time is reached. In some optional implementations, downlink data transmitted within the downlink transmission time window and uplink data transmitted within the uplink transmission time window are data belonging to the same service or application.

In an embodiment of the present disclosure, the first device may determine the starting time of the downlink transmission time window by the following manners.

Manner A: the first device determines the starting time of the downlink transmission time window as the time after the first device delays for a first duration after sending a first uplink data packet.

Manner B: The first device determines the starting time of the downlink transmission time window as the time after the first device delays for a second duration after receiving the first uplink data packet.

In the above solution, the first duration and the second duration may be configured by a network or predefined by a protocol.

### Second Solution

In an embodiment of the present disclosure, the first device includes at least one of: a terminal, an access network element, or a core network element, and the first transmission time window is a downlink transmission time window. The first device determines the starting time of the downlink transmission time window and opens the downlink transmission time window when the starting time is reached. Here, the access network element is, for example, a base station. The core network element is, for example, a UPF.

Here, the first device may refer to one device among the terminal, the access network element, and the core network element. For example, the first device is the core network element. Alternatively, the first device may include at least two devices among the terminal, the access network element, and the core network element. With regard to these situations, the at least two devices all determine the starting time of the downlink transmission time window, and open the downlink transmission time window when the starting time is reached. Using the core network element as an example, after opening the downlink transmission time window, the core network element sends downlink data to the access network element within the downlink transmission time window. Using the access network element as an example, after opening the downlink transmission time window, the access network element sends downlink data to the terminal within the downlink transmission time window. Using the terminal as an example, after opening the downlink transmission time window, the terminal receives downlink data, sent by the access network element, within the downlink transmission time window.

Here, when both the core network element and the access network element open the downlink transmission time window, the time when the core network element opens the downlink transmission time window is the same as the time when the access network element opens the downlink transmission time window, or the time when the core network element opens the downlink transmission time window is different from the time when the access network element opens the downlink transmission time window.

It should be noted that when time precision requirements are low, it may be considered that the time when the core network element opens the downlink transmission time window is the same as the time when the access network element opens the downlink transmission time window. When time precision requirements are high, it may be considered that the time when the core network element opens the downlink transmission time window is different from the time when the access network element opens the downlink transmission time window. This is because the transmission time between the core network element and the access network element is at the millisecond level, and the time of the downlink transmission time window is at the second level.

In an embodiment of the present disclosure, the first device may determine the starting time of the downlink transmission time window by the following manners.

Manner 1: the first device determines the starting time of the downlink transmission time window based on network configuration information.

Manner 2: the first device determines the starting time of the downlink transmission time window based on predefined information.

Manner 3: the first device determines the starting time of the downlink transmission time window based on implementation by the first device itself.

In some optional implementations, the first device determines the starting time of the downlink transmission time window as the time when the first device sends a first downlink data packet in a first QoS flow.

In some optional implementations, the first device determines the starting time of the downlink transmission time window as the time when the first device receives the first downlink data packet.

In some optional implementations, the first device determines the starting time of the downlink transmission time window as the time when the first device receives a second downlink data packet within a first time range after receiving the first downlink data packet.

As an implementation, when receiving the first downlink data packet, the first device opens the downlink transmission time window, and if the first device has not received the second downlink data packet within the first time range after receiving the first downlink data packet, then the first device closes the downlink transmission time window.

As another implementation, when receiving the first downlink data packet, the first device detects whether the second downlink data packet is received within the first time range. If the first device receives the second downlink data packet, then the first device opens the downlink transmission time window when the second downlink data packet is received or at the end moment of the first time range. If the first device has not received the second downlink data packet, then the first device determines not to open the downlink transmission time window.

In some optional implementations, within the downlink transmission time window, downlink data packet(s) is transmitted using the first QoS parameter, and outside of the downlink transmission time window, the downlink data packet(s) is transmitted using a second QoS parameter or not transmitted. Here, the second QoS parameter may be a QoS parameter of a lower level compared with the first QoS parameter.

Furthermore, in some optional implementations, the first device marks a downlink data packet transmitted within the downlink transmission time window using a first label, here, the downlink data packet marked with the first label is transmitted over an air interface using the first QoS parameter. Specifically, the downlink data packet marked with the first label is transmitted over the air interface using an air interface bearer corresponding to the first QoS parameter.

Furthermore, in some optional implementations, after performing downlink transmission within the downlink transmission time window, the first device may also perform uplink transmission within an uplink transmission time window. To this end, the first device determines the starting time of the uplink transmission time window, and opens the uplink transmission time window when the starting time is reached. In some optional implementations, uplink data transmitted within the uplink transmission time window and downlink data transmitted within the downlink transmission time window are data belonging to the same service or application.

In an embodiment of the present disclosure, the first device may determine the starting time of the uplink transmission time window by the following manners.

Manner A: the first device determines the starting time of the uplink transmission time window as the time after the first device delays for a third duration after sending a first downlink data packet.

Manner B: the first device determines the starting time of the uplink transmission time window as the time after the first device delays for a fourth duration after receiving the first downlink data packet.

In the above solution, the third duration and the fourth duration may be configured by a network or predefined by a protocol.

In some optional implementations, after the first transmission time window ends, the first device starts a first timer. The first transmission time window is not able to be opened during the running of the first timer, and the first transmission time window is able to be opened after the first timer expires. Specifically, the first transmission time window is not opened during the running of the first timer. After the first timer expires, the first transmission time window is opened upon reaching of the starting time of the first transmission time window. Here, the manner for determining the starting time of the first transmission time window may be understood with reference to the aforementioned related solutions that “the first device determines the starting time of the uplink transmission time window” and “the first device determines the starting time of the downlink transmission time window”.

It should be noted that in the above technical solutions of the embodiments of the present disclosure, the technical solution illustrated in FIG. 5 and the technical solution illustrated in FIG. 6 may be implemented separately or may be combined together for implementation.

It should be noted that in the above technical solutions of the embodiments of the present disclosure, the QoS control method may be applied to the following transmission path: terminal→uplink data transmission→application server→downlink data transmission, thereby implementing a QoS guarantee mechanism for uplink and downlink. The QoS control method may also be applied to the following transmission path: application server→downlink data transmission→terminal→uplink data transmission, thereby implementing a QoS guarantee mechanism for uplink and downlink.

The technical solutions of the embodiments of the present disclosure will be described below with reference to specific application examples.

### First Application Example

A PCF performs the configuration of an uplink QoS parameter and a downlink QoS parameter according to a requested RTD and/or RTBR, and issues the same to an SMF for establishment and/or bundling of a QoS flow. In addition, the PCF may also determine an uplink transmission time window and a downlink transmission time window according to requested time information. As an example, the starting time and ending time of the uplink transmission time window are t1 and t2, respectively, and the uplink transmission time window may be recorded as (t1 to t2). The starting time and ending time of the downlink transmission time window are t3 and t4, respectively, and the downlink transmission time window may be recorded as (t3 to t4).

FIG. 7 is a third schematic flowchart of a QoS control method provided in an embodiment of the present disclosure. As illustrated in FIG. 7, the QoS control method includes the following operations.

At operation 701a/b: a terminal or an application server sends a request message to a PCF, the request message carrying an RTD and/or an RTBR.

Here, the request message is used to request the establishment of a QoS flow under a specific QoS parameter and/or to ensure the transmission of a specific service data flow by using a specific QoS parameter.

Here, the request message carries a specific QoS parameter, i.e., an RTD and/or an RTBR. Here, the RTD is a round trip delay, and the RTBR is a round trip bit rate.

At operation 702: the PCF determines a PCC rule according to the RTD and/or the RTBR.

Here, the PCF determines an uplink QoS parameter and a downlink QoS parameter according to the RTD and/or the RTBR, and then determines the PCC rule. Here, the PCC rule includes the uplink QoS parameter and the downlink QoS parameter. As an example, the uplink QoS parameter includes an uplink delay and/or an uplink bit rate, and the downlink QoS parameter includes a downlink delay and/or a downlink bit rate.

Here, the PCF may separately define a value of the uplink QoS parameter and a value of the downlink QoS parameter based on a value (e.g., the RTD, the RTBR) of the round-trip QoS parameter by a third party (e.g., the terminal or the application server), as long as it is ensured that the value of the uplink QoS parameter and the value of the downlink QoS parameter are less than or equal to the value of the round-trip QoS parameter. For example, uplink delay+downlink delay≤RTD. For another example, uplink bit rate+downlink bit rate≤RTBR.

Furthermore, optionally, the PCC rule further includes SDF templates. Here, the SDF templates each include feature parameters describing service data flows, and the uplink data and downlink data belonging to the same service or application may be configured with corresponding SDF templates in a core network, where each SDF template corresponds to a different QoS parameter.

At operation 703: the PCF sends a request message to an SMF, the request message carrying the PCC rule.

At operation 704: the SMF interacts with a UPF, a base station, and the terminal, to perform the establishment and/or bundling of a QoS flow.

Here, a filter for a service data flow and a corresponding QoS parameter are determined based on the PCC rule. Here, the corresponding filter and QoS parameter are separately determined for uplink and downlink. A specific data packet screened out by the filter is bundled to a QoS flow corresponding to the QoS parameter for transmission, or a new QoS flow is established according to the QoS parameter for transmitting the data packet.

Here, two QoS flows may be used to transmit uplink data and downlink data of the same service or application, respectively. Alternatively, one QoS flow may be used to separately transmit uplink data and downlink data of the same service or application by using two sets of QoS parameters (e.g., an uplink QoS parameter and a downlink QoS parameter).

### Second Application Example

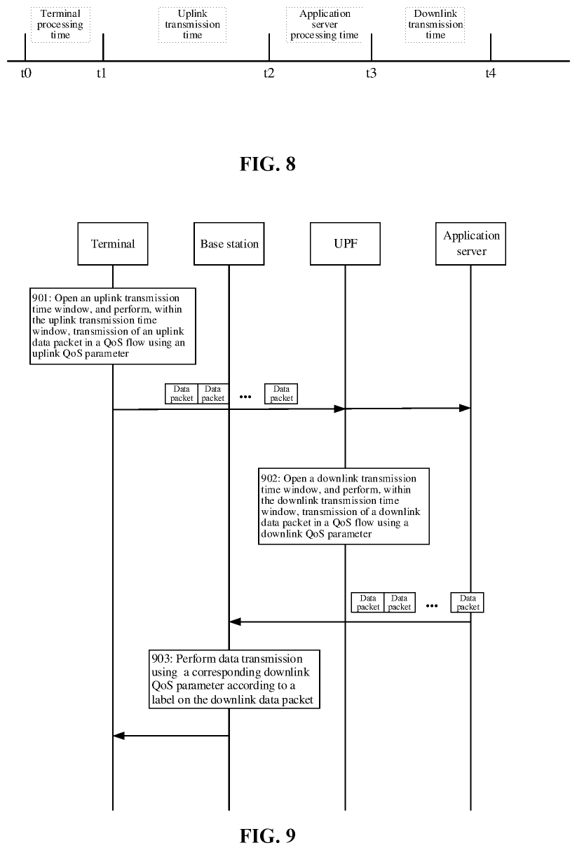

FIG. 8 schematically illustrates the time involved in a full round-trip data interaction process, including terminal processing time, uplink transmission time, application server processing time, and downlink transmission time. The uplink transmission time corresponds to an uplink transmission time window (t1 to t2), and the downlink transmission time corresponds to a downlink transmission time window (t3 to t4).

FIG. 9 is a fourth schematic flowchart of a QoS control method provided in an embodiment of the present disclosure. As illustrated in FIG. 9, the QoS control method includes the following operations.

At operation 901: a terminal opens an uplink transmission time window, and performs, within the uplink transmission time window, transmission of an uplink data packet in a QoS flow using an uplink QoS parameter.

Here, the terminal may determine the starting time t1 of the uplink transmission time window according to network configuration information, or may determine the starting time t1 of the uplink transmission time window according to predefined information, or may determine the starting time t1 of the uplink transmission time window according to implementation by the terminal itself.

As an implementation, when sending the first uplink data packet in the QoS flow, the terminal opens the uplink transmission time window, and performs, within the uplink transmission time window, transmission of the data packet using the uplink QoS parameter. Furthermore, optionally, at other times (i.e., the time outside of the uplink transmission time window), uplink data packets of the QoS flow are transmitted using other QoS parameters (e.g., QoS parameters of a lower level) or not transmitted.

At operation 902: a UPF opens a downlink transmission time window, and performs, within the downlink transmission time window, transmission of a downlink data packet in a QoS flow using a downlink QoS parameter.

Here, the UPF may determine the starting time t3 of the downlink transmission time window according to network configuration information, or may determine the starting time t3 of the downlink transmission time window according to predefined information, or may determine the starting time t3 of the downlink transmission time window according to implementation by the UPF itself.

As an implementation, after detecting the first uplink data packet, the UPF delays for a certain duration opening the downlink transmission time window, and performs, within the downlink transmission time window, transmission of the data packet using the downlink QoS parameter. Furthermore, optionally, at other times (i.e., the time outside of the downlink transmission time window), downlink data packets of the QoS flow are transmitted using other QoS parameters (e.g., QoS parameters of a lower level) or not transmitted.

It should be noted that the terminal and/or UPF considers that downlink data within the downlink transmission time window corresponds to uplink data transmitted within the uplink transmission time window. The meaning of “corresponding” may be downlink data processed and sent by the application server after receiving uplink data.

Optionally, the UPF may mark a label for each downlink data packet, the label indicating that the data packet is transmitted using a particular downlink QoS parameter. For example, the UFP may mark a label in a GTP-U header of a data packet so as to facilitate a base station and/or terminal to perform data transmission using a corresponding downlink QoS parameter.

At operation 903: after receiving the downlink data packet sent by the UPF, a base station may perform data transmission using, according to the label on the downlink data packet, a corresponding downlink QoS parameter.

Specifically, the data transmission may be performed using an air interface bearer corresponding to the QoS parameter. Here, the label may be a newly designed label, or may reference existing labels.

Optionally, after the transmission time window ends, the terminal and/or UPF may start a timer, and after the timer expires (that is, after a period of time), a new transmission time window may be opened again later.

### Third Application Example

FIG. 8 schematically illustrates the time involved in a full round-trip data interaction process, including terminal processing time, uplink transmission time, application server processing time, and downlink transmission time. The uplink transmission time corresponds to an uplink transmission time window (t1 to t2), and the downlink transmission time corresponds to a downlink transmission time window (t3 to t4).

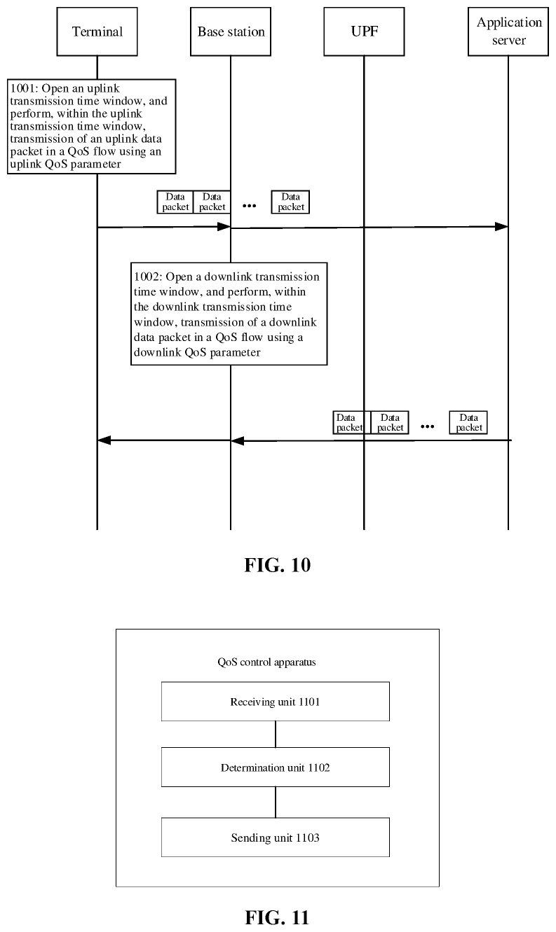

FIG. 10 is a fifth schematic flowchart of a QoS control method provided in an embodiment of the present disclosure. As illustrated in FIG. 10, the QoS control method includes the following operations.

At operation 1001: a terminal opens an uplink transmission time window, and performs, within the uplink transmission time window, transmission of an uplink data packet in a QoS flow using an uplink QoS parameter.

Here, the terminal may determine the starting time t1 of the uplink transmission time window according to network configuration information, or may determine the starting time t1 of the uplink transmission time window according to predefined information, or may determine the starting time t1 of the uplink transmission time window according to implementation by the terminal itself.

As an implementation, when sending the first uplink data packet in the QoS flow, the terminal opens the uplink transmission time window, and performs, within the uplink transmission time window, transmission of the data packet using the uplink QoS parameter. Furthermore, optionally, at other times (i.e., the time outside of the uplink transmission time window), uplink data packets of the QoS flow are transmitted using other QoS parameters (e.g., QoS parameters of a lower level) or not transmitted.

At operation 1002: the base station opens a downlink transmission time window, and performs, within the downlink transmission time window, transmission of a downlink data packet in a QoS flow using a downlink QoS parameter.

Here, the base station may determine the starting time t3 of the downlink transmission time window according to network configuration information, or may determine the starting time t3 of the downlink transmission time window according to predefined information, or may determine the starting time t3 of the downlink transmission time window according to implementation by the base station itself.

As an implementation, after detecting the first uplink data packet, the base station delays for a certain duration opening the downlink transmission time window, and performs, within the downlink transmission time window, transmission of the data packet using the downlink QoS parameter. Furthermore, optionally, at other times (i.e., the time outside of the downlink transmission time window), downlink data packets of the QoS flow are transmitted using other QoS parameters (e.g., QoS parameters of a lower level) or not transmitted.

It should be noted that the terminal and/or base station considers that downlink data within the downlink transmission time window corresponds to uplink data transmitted within the uplink transmission time window. The meaning of “corresponding” may be downlink data processed and sent by the application server after receiving uplink data.

Optionally, the base station may mark a label for each downlink data packet, the label indicating that the data packet is transmitted using a particular downlink QoS parameter. For example, the base station may mark a label in a header of a data packet so as to facilitate the base station and/or terminal to perform data transmission using a corresponding downlink QoS parameter. Specifically, the data transmission may be performed using an air interface bearer corresponding to the QoS parameter. Here, the label may be a newly designed label, or may reference existing labels.

Optionally, after the transmission time window ends, the terminal and/or base station may start a timer, and after the timer expires (that is, after a period of time), a new transmission time window may be opened again later.

It should be noted that the technical solution described in the second application example above and the technical solution described in the third application example may be implemented separately, or may be combined together for implementation. When combined together for implementation, for an application scenario in which time precision requirements are low, it may be considered that the time when the UPF opens the downlink transmission time window is the same as the time when the base station opens the downlink transmission time window; for an application scenario in which time precision requirements are high, it may be considered that the time when the UPF opens the downlink transmission time window is different from the time when the base station opens the downlink transmission time window. This is because the time for a data packet to be sent from the UPF to the base station is generally at a millisecond level, and the time for the transmission time window is generally at a second level. If the transmission time from the UPF to the base station can be ignored, then it is considered that the time when the UPF opens the downlink transmission time window and the time when the base station opens the downlink transmission time window are the same. If the transmission time from the UPF to the base station cannot be ignored, then it is considered that the time when the UPF opens the downlink transmission time window and the time when the base station opens the downlink transmission time window are different.

It should be noted that the technical solution described in the second application example above and the technical solution described in the third application example are exemplified by the following transmission path: terminal→uplink data transmission→application server→downlink data transmission, but the technical solutions of the present disclosure may also be applied to a reverse transmission path: application server→downlink data transmission→terminal→uplink data transmission, both of which can achieve the objective of ensuring round-trip QoS requirements.

Preferred embodiments of the present disclosure are described in detail above with reference to the drawings, but the present disclosure is not limited to specific details in the above implementations. Within the scope of the technical concept of the present disclosure, a variety of simple variations may be made to the technical solutions of the present disclosure, and all of these simple variations fall within the scope of protection of the present disclosure. For example, various specific technical features described in the above specific implementations may be combined by using any suitable means without contradictions. To avoid unnecessary repetition, the present disclosure no longer describes the various possible combinations. For another example, any combination of different implementations of the present disclosure may also be made, as long as the same does not violate the ideas of the present disclosure, which should likewise be considered content disclosed in the present disclosure. For another example, insofar as there are no conflicts, various embodiments described in the present disclosure and/or technical features in various embodiments may be arbitrarily combined with the prior art, and the technical solutions obtained after the combination should also fall within the scope of protection of the present disclosure.

It should be understood that in various method embodiments of the present disclosure, the size of the sequence numbers of various processes described above does not imply the order of execution, and the order of execution of various processes should be determined by functions and internal logic thereof, and should not constitute any limitation on the implementation processes of the embodiments of the present disclosure. In addition, in the embodiments of the present disclosure, the terms “downlink”, “uplink”, and “sidelink” are used to denote the transmission direction of a signal or data, wherein “downlink” is used to indicate that the transmission direction of the signal or data is a first direction of sending from a station to a user equipment of a cell, “uplink” is used to indicate that the transmission direction of the signal or data is a second direction of sending from the user equipment of the cell to the station, and “sidelink” is used to indicate that the transmission direction of the signal or data is a third direction of sending from user equipment 1 to user equipment 2. For example, a “downlink signal” indicates that the transmission direction of the signal is the first direction. In addition, in the embodiments of the present disclosure, the term “and/or” herein is merely to describe the associations of associated objects, indicating that there may be three kinds of relationships. Specifically, A and/or B may indicate three situations in which A exists alone, A and B exist simultaneously, or B exists alone. In addition, the character “/” herein generally indicates that the associated objects before and after this character are in an “or” relationship.

FIG. 11 is a first schematic diagram of the structural composition of a QoS control apparatus according to an embodiment of the present disclosure, which is applied to a first node. As illustrated in FIG. 11, the QoS control apparatus includes a receiving unit 1101 and a determination unit 1102.

The receiving unit 1101 is configured to receive a first request message sent by a second node, here, the first request message carries at least one of: a value of a round-trip QoS parameter or transmission time information.

The determination unit 1102 is configured to determine a value of an uplink QoS parameter and a value of a downlink QoS parameter based on the value of the round-trip QoS parameter, and/or to determine an uplink transmission time window and a downlink transmission time window based on the transmission time information.

In some optional implementations, the sum of the value of the uplink QoS parameter and the value of the downlink QoS parameter is less than or equal to the value of the round-trip QoS parameter.

In some optional implementations, the uplink QoS parameter is applied to transmission of uplink data, and the downlink QoS parameter is applied to transmission of downlink data, here, the uplink data and the downlink data are data belonging to the same service or application.

In some optional implementations, the determination unit 1102 is configured to determine a first rule, here, the first rule includes the value of the uplink QoS parameter and the value of the downlink QoS parameter.

The apparatus further includes: a sending unit 1103 configured to send the first rule to a third node, here, the first rule is used by the third node for establishment and/or bundling of a QoS flow.

In some optional implementations, the QoS flow includes an uplink QoS flow and a downlink QoS flow, here, a QoS parameter used by the uplink QoS flow is the uplink QoS parameter, and a QoS parameter used by the downlink QoS flow is the downlink QoS parameter.

In some optional implementations, the uplink QoS flow and the downlink QoS flow are the same QoS flow, or the uplink QoS flow and the downlink QoS flow are different QoS flows.

In some optional implementations, the third node is a session management network element.

In some optional implementations, the uplink transmission time window is applicable to uplink data transmission using the uplink QoS parameter, and the downlink transmission time window is applicable to downlink data transmission using the downlink QoS parameter.

In some optional implementations, the round-trip QoS parameter includes at least one of: round-trip delay or round-trip bit rate.

In some optional implementations, the uplink QoS parameter includes at least one of: uplink delay or uplink bit rate.

In some optional implementations, the downlink QoS parameter includes at least one of: downlink delay or downlink bit rate.

In some optional implementations, the first node is a policy control network element.

In some optional implementations, the second node is a terminal or an application server.

It should be understood by those skilled in the art that the relevant description of the above QoS control apparatus in the embodiments of the present disclosure may be understood with reference to the relevant description of the QoS control method in the embodiments of the present disclosure.

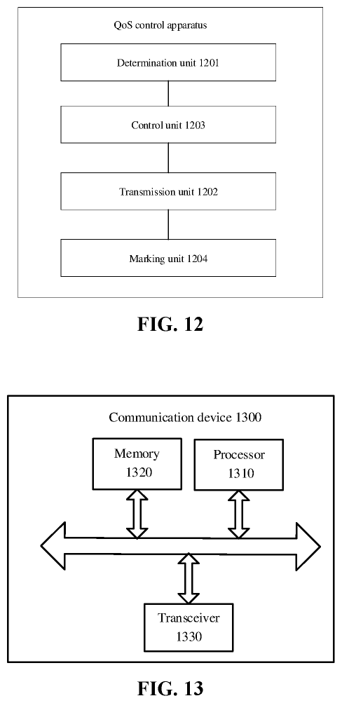

FIG. 12 is a second schematic diagram of the structural composition of a QoS control apparatus according to an embodiment of the present disclosure, which is applied to a first device. As illustrated in FIG. 12, the QoS control apparatus includes a determination unit 1201 and a transmission unit 1202.

The determination unit 1201 is configured to determine a first transmission time window corresponding to a first QoS parameter.

The transmission unit 1202 is configured to perform, within the first transmission time window, data transmission using the first QoS parameter.

In some optional implementations, the first device includes at least one of: a terminal, an access network element, or a core network element, and the first transmission time window is an uplink transmission time window.

In some optional implementations, the determination unit 1201 is configured to determine the starting time of the uplink transmission time window, and open the uplink transmission time window when the starting time is reached.

In some optional implementations, the determination unit 1201 is configured to determine the starting time of the uplink transmission time window based on network configuration information, or determine the starting time of the uplink transmission time window based on predefined information, or determine the starting time of the uplink transmission time window based on implementation by the first device itself.

In some optional implementations, the determination unit 1201 is configured to determine the starting time of the uplink transmission time window as the time when the first device sends a first uplink data packet in a first QoS flow.

In some optional implementations, within the uplink transmission time window, an uplink data packet in the first QoS flow is transmitted using the first QoS parameter, and outside of the uplink transmission time window, the uplink data packet in the first QoS flow is transmitted using a second QoS parameter or is not transmitted.

In some optional implementations, the determination unit 1201 is configured to determine the starting time of a downlink transmission time window, and open the downlink transmission time window when the starting time is reached, here, downlink data transmitted within the downlink transmission time window and uplink data transmitted within the uplink transmission time window are data belonging to the same service or application.

In some optional implementations, the determination unit 1201 is configured to determine the starting time of the downlink transmission time window as the time after the first device delays for a first duration after sending a first uplink data packet, or the time after the first device delays for a second duration after receiving the first uplink data packet.

In some optional implementations, the first device includes at least one of: a terminal, an access network element, or a core network element, and the first transmission time window is a downlink transmission time window.

In some optional implementations, the determination unit 1201 is configured to determine the starting time of the downlink transmission time window, and open the downlink transmission time window when the starting time is reached.

In some optional implementations, the determination unit 1201 is configured to determine the starting time of the downlink transmission time window based on network configuration information, or determine the starting time of the downlink transmission time window based on predefined information, or determine the starting time of the downlink transmission time window based on implementation by the first device itself.

In some optional implementations, the determination unit 1201 is configured to determine the starting time of the downlink transmission time window as the time when the first device sends a first downlink data packet in a first QoS flow, or the time when the first device receives the first downlink data packet, or the time when the first device receives a second downlink data packet within a first time range after receiving the first downlink data packet.

In some optional implementations, the apparatus further includes: a control unit 1203 configured to: open the downlink transmission time window when receiving the first downlink data packet, and if the second downlink data packet is not received within the first time range after receiving the first downlink data packet, then close the downlink transmission time window; or when receiving the first downlink data packet, detect whether the second downlink data packet is received within the first time range, if the second downlink data packet is received, then open the downlink transmission time window when the second downlink data packet is received or at an end moment of the first time range, and if the second downlink data packet is not received, not open the downlink transmission time window.

In some optional implementations, the apparatus further includes: a marking unit 1204 configured to mark a downlink data packet transmitted within the downlink transmission time window using a first label, here, the downlink data packet marked with the first label is transmitted over an air interface using the first QoS parameter.

In some optional implementations, the downlink data packet marked with the first label is transmitted over the air interface using the first QoS parameter, which includes that the downlink data packet marked with the first label is transmitted over the air interface using an air interface bearer corresponding to the first QoS parameter.

In some optional implementations, the determination unit 1201 is configured to determine the starting time of the uplink transmission time window, and open the uplink transmission time window when the starting time is reached, here, uplink data transmitted within the uplink transmission time window and downlink data transmitted within the downlink transmission time window are data belonging to the same service or application.

In some optional implementations, the determination unit 1201 is configured to determine the starting time of the uplink transmission time window as the time after the first device delays for a third duration after sending a first downlink data packet, or the time after the first device delays for a fourth duration after receiving the first downlink data packet.

In some optional implementations, within the downlink transmission time window, a downlink data packet is transmitted using the first QoS parameter, and outside of the downlink transmission time window, the downlink data packet is transmitted using a second QoS parameter or is not transmitted.

In some optional implementations, the time when the core network element opens the downlink transmission time window is the same as the time when the access network element opens the downlink transmission time window, or the time when the core network element opens the downlink transmission time window is different from the time when the access network element opens the downlink transmission time window.

In some optional implementations, the control unit 1203 is configured to start a first timer after the first transmission time window ends. The first transmission time window is not opened during the running of the first timer, and the first transmission time window is opened upon reaching of the starting time of the first transmission time window after the first timer expires.

It should be understood by a person skilled in the art that the relevant description of the above QoS control apparatus in the embodiments of the present disclosure may be understood with reference to the relevant description of the QoS control method in the embodiments of the present disclosure.

FIG. 13 is a schematic structural diagram of a communication device 1300 provided in an embodiment of the present disclosure. The communication device may be the first node in the above solutions, or may be the first device in the above solutions. The communication device 1300 illustrated in FIG. 13 includes a processor 1310. The processor 1310 may invoke and run a computer program from a memory so as to implement the methods in the embodiments of the present disclosure.

Optionally, as illustrated in FIG. 13, the communication device 1300 may also include a memory 1320. The processor 1310 may invoke and run a computer program from the memory 1320 so as to implement the methods in the embodiments of the present disclosure.

The memory 1320 may be one separate component independent of the processor 1310, or may be integrated in the processor 1310.

Optionally, as illustrated in FIG. 13, the communication device 1300 may further include a transceiver 1330. The processor 1310 may control the transceiver 1330 to perform communication with other devices. Specifically, the transceiver may send information or data to other devices, or receive information or data sent by other devices.

The transceiver 1330 may include a transmitter and a receiver. The transceiver 1330 may further include an antenna, and the number of antennas may be one or more.

Optionally, the communication device 1300 may specifically be the first node in the embodiments of the present disclosure, and the communication device 1300 may implement corresponding processes implemented by the first node in the respective methods of the embodiments of the present disclosure, which will not be repeated here for the sake of brevity.

Optionally, the communication device 1300 may specifically be the first device in the embodiments of the present disclosure, and the communication device 1300 may implement corresponding processes implemented by the first device in the respective methods of the embodiments of the present disclosure, which will not be repeated here for the sake of brevity.

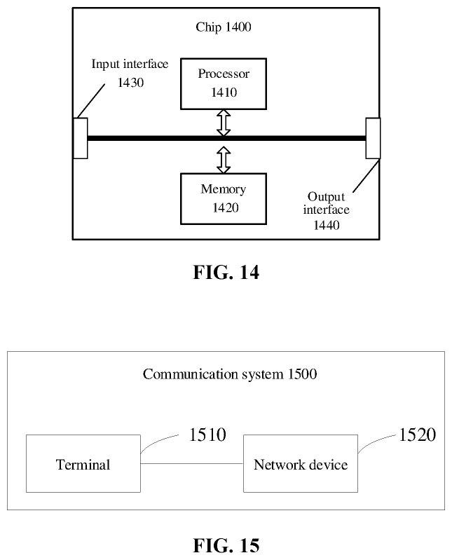

FIG. 14 is a schematic structural diagram of a chip according to an embodiment of the present disclosure. The chip 1400 illustrated in FIG. 14 includes a processor 1410. The processor 1410 may invoke and run a computer program from a memory so as to implement the methods in the embodiments of the present disclosure.

Optionally, as illustrated in FIG. 14, the chip 1400 may further include a memory 1420. The processor 1410 may invoke and run a computer program from the memory 1420 so as to implement the methods in the embodiments of the present disclosure.

The memory 1420 may be one separate component independent of the processor 1410, or may be integrated in the processor 1410.

Optionally, the chip 1400 may further include an input interface 1430. The processor 1410 may control the input interface 1430 to perform communication with other devices or chips. Specifically, the input interface may obtain information or data sent by other devices or chips.

Optionally, the chip 1400 may further include an output interface 1440. The processor 1410 may control the output interface 1440 to perform communication with other devices or chips. Specifically, the output interface may output information or data to other devices or chips.

Optionally, the chip may be applied to the first node in the embodiments of the present disclosure, and the chip may implement corresponding processes implemented by the first node in the respective methods of the embodiments of the present disclosure, which will not be repeated here for the sake of brevity.

Optionally, the chip may be applied to the first device in the embodiments of the present disclosure, and the chip may implement corresponding processes implemented by the first device in the respective methods of the embodiments of the present disclosure, which will not be repeated here for the sake of brevity.

It should be understood that the chip mentioned in the embodiment of the present disclosure may also be referred to as a system-level chip, a system chip, a chip system, or a system-on-chip chip, or the like.

FIG. 15 is a schematic block diagram of a communication system 1500 provided in an embodiment of the present disclosure. As illustrated in FIG. 15, the communication system 1500 includes a terminal 1510 and a network device 1520.

The terminal 1510 may be used for implementing corresponding functions implemented by the terminal in the methods described above, and the network device 1520 may be used for implementing corresponding functions implemented by the network device in the methods described above, which will not be repeated here for the sake of brevity.

It should be understood that the processor in the embodiments of the present disclosure may be an integrated circuit chip with a signal processing capability. During implementation, each operation in the method embodiments described above may be completed by an integrated logic circuit of hardware in a processor or instructions in the form of software. The above processor may be a general-purpose processor, a digital signal processor (DSP), an application-specific integrated circuit (ASIC), a field-programmable gate array (FPGA), or other programmable logic devices, a discrete gate or transistor logic device, or a discrete hardware component. The various methods, operations, and logical block diagrams disclosed in the embodiments of the present disclosure may be implemented or executed. The general-purpose processor may be a microprocessor, or the processor may also be any conventional processor, or the like. The operations of the methods disclosed in combination with the embodiments of the present disclosure may be directly executed and completed by a hardware decoding processor, or executed and completed by a combination of hardware and software modules in the decoding processor. Software modules may be located in a mature storage medium in the present field such as a random access memory, a flash memory, a read-only memory, a programmable read-only memory, an electrically erasable programmable memory, or a register. The storage medium is located in the memory, and the processor reads the information in the memory, and completes the operations of the above methods in combination with its hardware.

It can be understood that the memory in the embodiments of the present disclosure may be a volatile memory or a nonvolatile memory, or may include both volatile and nonvolatile memories. The non-volatile memory may be a read-only memory (ROM), a programmable read-only memory (programmable ROM, PROM), an erasable programmable read-only memory (erasable PROM, EPROM), an electrically erasable programmable read-only memory (Electrically EPROM, EEPROM), or a flash memory. The volatile memory may be random access memory (RAM), which acts as an external cache. By way of example, but not by way of limitation, many forms of RAMs are available, such as static random access memories (static RAM, SRAM), dynamic random access memories (dynamic RAM, DRAM), synchronous dynamic random access memories (synchronous DRAM, SDRAM), double data rate synchronous dynamic random access memories (double data rate SDRAM, DDR SDRAM), enhanced synchronous dynamic random access memories (enhanced SDRAM, ESDRAM), synchronous link dynamic random access memories (synchlink DRAM, SLDRAM), and direct memory bus random access memories (direct rambus RAM, DR RAM). It should be noted that the memory in the systems and methods described herein is intended to include, but is not limited to, the foregoing and any other suitable type of memory.

It should be understood that the above-mentioned memory is illustrative but not restrictive. For example, the memory in the embodiments of the present disclosure may also be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchronous link dynamic random access memory (synch link DRAM, SLDRAM), a direct memory bus random access memory (Direct Rambus RAM, DR RAM), or the like. That is, the memory in the embodiments of the present disclosure is intended to include, but is not limited to, the foregoing and any other suitable type of memory.

An embodiment of the present disclosure further provides a computer-readable storage medium for storing a computer program.

Optionally, the computer-readable storage medium may be applied to the first node in the embodiments of the present disclosure, and the computer program causes a computer to perform corresponding processes implemented by the first node in the respective methods of the embodiments of the present disclosure, which will not be repeated here for the sake of brevity.

Optionally, the computer-readable storage medium may be applied to the first device in the embodiments of the present disclosure, and the computer program causes a computer to perform corresponding processes implemented by the first device in the respective methods of the embodiments of the present disclosure, which will not be repeated here for the sake of brevity.

An embodiment of the present disclosure further provides a computer program product including computer program instructions.

Optionally, the computer program product may be applied to the first node in the embodiments of the present disclosure, and the computer program instructions cause a computer to perform corresponding processes implemented by the first node in the respective methods of the embodiments of the present disclosure, which will not be repeated here for the sake of brevity.

Optionally, the computer program product may be applied to the first device in the embodiments of the present disclosure, and the computer program instructions cause a computer to perform corresponding processes implemented by the first device in the respective methods of the embodiments of the present disclosure, which will not be repeated here for the sake of brevity.

An embodiment of the present disclosure further provides a computer program.

Optionally, the computer program may be applied to the first node in the embodiments of the present disclosure, and the computer program, when run on a computer, causes the computer to perform corresponding processes implemented by the first node in the respective methods of the embodiments of the present disclosure, which will not be repeated here for the sake of brevity.

Optionally, the computer program may be applied to the first device in the embodiments of the present disclosure, and the computer program, when run on a computer, causes the computer to perform corresponding processes implemented by the first device in the respective methods of the embodiments of the present disclosure, which will not be repeated here for the sake of brevity.

Those skilled in the art can appreciate that the units and algorithm operations of the examples described in combination with the embodiments disclosed herein can be implemented by electronic hardware, or a combination of computer software and electronic hardware. These functions are executed in hardware or software, depending on the specific applications and design constraints of the technical solutions. A professional skilled person may use different methods for each specific application to implement the described functions, but said implementation should not be considered to exceed the scope of the present disclosure.

It can be clearly understood by a person skilled in the art that for the convenience and brevity of the description, reference may be made to the corresponding processes in the foregoing method embodiments for the specific working processes of the systems, apparatuses, and units described above, which will not be repeated here.

In several embodiments provided by the present disclosure, it should be understood that the disclosed systems, apparatuses, and methods may be implemented by other means. For example, the apparatus embodiments described above are merely illustrative. For example, the division of the units is only a logical function division. During actual implementation, there may be other division methods. For example, a plurality of units or components may be combined or integrated into another system, or some features may be ignored or not implemented. Furthermore, the displayed or discussed coupling or direct coupling or communication connections may be by means of some interfaces, and the indirect coupling or communication connections of apparatuses or units may be in electrical, mechanical, or other forms.

The units described as separate components may or may not be physically separated, and the components displayed as units may or may not be physical units, that is, they may be located in one place, or may be distributed to a plurality of network units. A part or all of the units may be selected according to actual needs to achieve the objective of the solutions of the present embodiments.

In addition, the functional units in various embodiments of the present disclosure may be integrated in one processing unit, or each unit may be individually physically present, or two or more units may be integrated into one unit.

If the functions described above are implemented in the form of software function units and sold or used as separate products, they may be stored in a computer-readable storage medium. On the basis of such understanding, a part of the technical solutions of the present disclosure that essentially contributes to the prior art, or a part of the technical solutions may be embodied in the form of a software product, and the computer software product is stored in a storage medium, including several instructions used for making a computer device (which may be a personal computer, a server, a network device, or the like) perform all or part of the operations of the methods described in the various embodiments of the present disclosure. The foregoing storage medium includes: a U disk, a mobile hard disk, a read-only memory (ROM), a random access memory (RAM), a magnetic disk, an optical disk, or other media that can store program codes.

The detailed description of the present disclosure is merely described above, but the scope of protection of the present disclosure is not limited thereto. Any person skilled in the art can easily conceive of changes or substitutions within the technical scope disclosed in the present disclosure, and all of the changes or substitutions should be covered by the scope of protection of the present disclosure. Therefore, the scope of protection of the present disclosure should be defined by the scope of protection of the claims.

1. A quality of service (QoS) control method, the method comprising:
receiving, by a first node, a first request message sent by a second node, the first request message carrying at least one of: a value of a round-trip QoS parameter or transmission time information; and
determining, by the first node, a value of an uplink QoS parameter and a value of a downlink QoS parameter based on the value of the round-trip QoS parameter, and/or determining an uplink transmission time window and a downlink transmission time window based on the transmission time information.

2. The method according to claim 1, wherein a sum of the value of the uplink QoS parameter and the value of the downlink QoS parameter is less than or equal to the value of the round-trip QoS parameter.

3. The method according to claim 1, further comprising:
determining, by the first node, a first rule, the first rule comprising the value of the uplink QoS parameter and the value of the downlink QoS parameter; and
sending, by the first node, the first rule to a third node, the first rule being used by the third node for establishment and/or bundling of a QoS flow.

4. The method according to claim 3, wherein the QoS flow comprises an uplink QoS flow and a downlink QoS flow, a QoS parameter used by the uplink QoS flow is the uplink QoS parameter, and a QoS parameter used by the downlink QoS flow is the downlink QoS parameter.

5. The method according to claim 4, wherein
the uplink QoS flow and the downlink QoS flow are the same QoS flow; or,
the uplink QoS flow and the downlink QoS flow are different QoS flows.

6. The method according to claim 1, wherein the round-trip QoS parameter comprises at least one of: round-trip delay or round-trip bit rate.

7. The method according to claim 1, wherein the uplink QoS parameter comprises uplink delay, and the downlink QoS parameter comprises downlink delay.

8. The method according to claim 1, wherein the first node is a policy control network element, and the second node is a terminal or an application server.

9. The method according to claim 1, wherein the uplink QoS parameter is applied to transmission of uplink data, and the downlink QoS parameter is applied to transmission of downlink data, the uplink data and the downlink data being data belonging to the same service or application.

10. A quality of service (QoS) control apparatus, which is applied to a first node, the apparatus comprising:
a transceiver;
a processor; and
a memory for storing a computer program that, when executed by the processor, causes the processor to:
receive, through the transceiver, a first request message sent by a second node, the first request message carrying at least one of: a value of a round-trip QoS parameter or transmission time information; and
determine a value of an uplink QoS parameter and a value of a downlink QoS parameter based on the value of the round-trip QoS parameter, and/or to determine an uplink transmission time window and a downlink transmission time window based on the transmission time information.

11. The apparatus according to claim 10, wherein a sum of the value of the uplink QoS parameter and the value of the downlink QoS parameter is less than or equal to the value of the round-trip QoS parameter.

12. The apparatus according to claim 10, wherein the processor is configured to:
determine a first rule, the first rule comprising the value of the uplink QoS parameter and the value of the downlink QoS parameter; and
send, through the transceiver, the first rule to a third node, the first rule being used by the third node for establishment and/or bundling of a QoS flow.

13. The apparatus according to claim 12, wherein the QoS flow comprises an uplink QoS flow and a downlink QoS flow, a QoS parameter used by the uplink QoS flow is the uplink QoS parameter, and a QoS parameter used by the downlink QoS flow is the downlink QoS parameter.

14. The apparatus according to claim 13, wherein
the uplink QoS flow and the downlink QoS flow are the same QoS flow; or,
the uplink QoS flow and the downlink QoS flow are different QoS flows.

15. The apparatus according to claim 10, wherein the round-trip QoS parameter comprises at least one of: round-trip delay or round-trip bit rate.

16. The apparatus according to claim 10, wherein the uplink QoS parameter comprises uplink delay, and the downlink QoS parameter comprises downlink delay.

17. The apparatus according to claim 10, wherein the first node is a policy control network element, and the second node is a terminal or an application server.

18. The apparatus according to claim 10, wherein the uplink QoS parameter is applied to transmission of uplink data, and the downlink QoS parameter is applied to transmission of downlink data, the uplink data and the downlink data being data belonging to the same service or application.

19. A quality of service (QoS) control apparatus, which is applied to a second node, the apparatus comprising:
a transceiver;
a processor; and
a memory for storing a computer program that, when executed by the processor, causes the processor to send, through the transceiver, a first request message to a first node, the first request message carrying at least one of: a value of a round-trip QoS parameter or transmission time information;
wherein the value of the round-trip QoS parameter is used by the first node to determine a value of an uplink QoS parameter and a value of a downlink QoS parameter, and/or the transmission time information is used by the first node to determine an uplink transmission time window and a downlink transmission time window.

20. The apparatus according to claim 19, wherein a sum of the value of the uplink QoS parameter and the value of the downlink QoS parameter is less than or equal to the value of the round-trip QoS parameter.
